(19) United States
(12) Patent Application Publication
(10) Pub. No.: US 2011/0040563 A1
(43) Pub. Date: Feb. 17, 2011

(54) Voice Control Device and Voice Control Method and Display Device

(76) Inventors: Xie-Ren Hsu, Hsinchu City (TW); Kuang-Feng Sung, Taichung County (TW)

Correspondence Address: NORTH AMERICA INTELLECTUAL PROPERTY CORPORATION, P.O. BOX 506, MERRIFIELD, VA, 22116, US

(21) Appl. No.: 12/700,743

(22) Filed: Feb. 5, 2010

(30) Foreign Application Priority Data
Aug. 14, 2009 (TW) 098127376

(51) Int. Cl. G10L 15/00

(52) U.S. Cl. 704/270; 704/E15.001

(57) ABSTRACT

A voice control device for a display device includes a voice receiver for receiving a voice signal, a voice recognition unit coupled to the voice receiver for recognizing the voice signal to generate a recognition result, a function decision unit coupled to the voice recognition unit for selecting an operating function from a plurality of operating functions according to the recognition result, and an execution unit coupled to the function decision unit for controlling the display device to perform the operating function.

### BACKGROUND OF THE INVENTION

1. Field of the Invention

The present invention relates to a voice control device and voice control method and display device, and more particularly, to a voice control device and voice control method and display device capable of enhancing utilization convenience.

2. Description of the Prior Art

With the advancement of entertainment and multimedia industry, television (TV) set has become one of the major leisure appliances for most people. TV set can not only present TV programs received from cable or radio channel, but also show images from DVD, Blu-Ray players, game consoles, computer systems and other devices. Also, in addition to display quality, TV set has obvious progress in functionality, such as video recording, picture in picture, memory card reading, automatic brightness adjustment, and so on.

However, to control the TV set, there are two typical ways, one is pressing buttons formed on a housing of the TV set, and the other is using a remote controller. Take the remote controller for example, when a user wants to control the TV set to execute a function, e.g. in-/decrease volume, the user can press a button corresponding to the function on the remote controller, such that the remote controller can emit a remote control signal. After receiving the remote control signal, the TV set can execute the related function. In general, a size of characters capable of being shown on the remote controller is limited; in other words, users having poor eyesight may encounter troubles as using the remote controller. For example, when a user with presbyopia wants to use the push-button remote controller, the user often needs to wear glasses to operate the remote controller, and takes off the glasses to see TV program, causing inconvenience each time the user wants to use the remote controller.

In addition, as the TV set includes more multimedia functions, functions to be controlled by the remote controller are becoming complicated, and not limited to channel or volume adjustment. In such a situation, the user, having poor eyesight or unfamiliar with new functions, often needs to overcome some difficulties, e.g. to know how to use some buttons or what the buttons mean. Meanwhile, because the user does not know how to use and may be afraid of using the buttons, the user maybe worry about damaging the TV set or changing parameters of the TV set if inadvertently touching the buttons, causing unnecessary stress when using the remote controller.

### SUMMARY OF THE INVENTION

It is therefore an objective of the present invention to provide voice control device, voice control method and display device.

The present invention discloses a voice control device for a display device, which comprises a voice receiver for receiving a voice signal, a voice recognition unit coupled to the voice receiver for recognizing the voice signal to generate a recognition result, a function decision unit coupled to the voice recognition unit for selecting an operating function from a plurality of operating functions according to the recognition result, and an execution unit coupled to the function decision unit for controlling the display device to perform the operating function.

The present invention further discloses a voice control method for a display device, which comprises receiving a voice signal for recognizing the voice signal to generate a recognition result, selecting an operating function from a plurality of operating functions according to the recognition result, and controlling the display device to perform the operating function.

The present invention further discloses a display device, which comprises a screen, a processing circuit for receiving a video signal and displaying pictures corresponding to the video signal on the screen, and a voice control device. The voice control device comprises a voice receiver for receiving a voice signal, a voice recognition unit coupled to the voice receiver for recognizing the voice signal to generate a recognition result, a function decision unit coupled to the voice recognition unit for selecting an operating function from a plurality of operating functions according to the recognition result, and an execution unit coupled to the function decision unit for controlling the processing circuit to perform the operating function.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a display device according to an embodiment of the present invention.

FIGS. 2A, 2B, 2C and 2D are schematic diagrams of different embodiments of a voice control device shown in FIG. 1.

FIGS. 3A, 3B and FIGS. 4A, 4B are schematic diagrams of the display device shown in FIG. 1 under different operations.

FIG. 5 is a schematic diagram of a modified embodiment of the display device shown in FIG. 1.

FIG. 6 is a schematic diagram of a voice control procedure according to an embodiment of the present invention.

### DETAILED DESCRIPTION

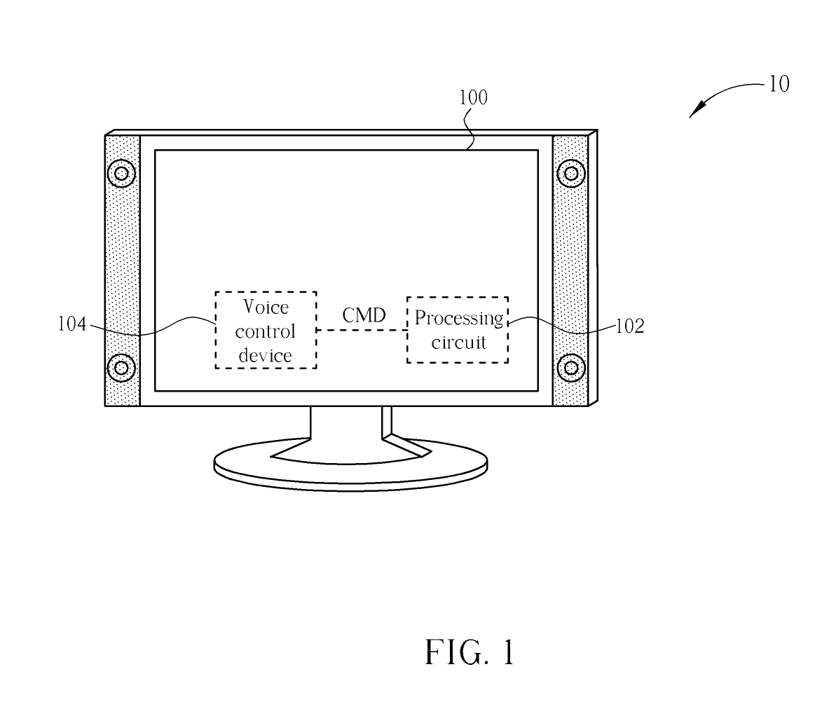

Please refer to FIG. 1. FIG. 1 is a schematic diagram of a display device 10 according to an embodiment of the present invention. The display device 10 is preferably a television (TV) set, and comprises a screen 100, a processing circuit 102, and a voice control device 104. The processing circuit 102 is utilized for receiving a video signal and displaying pictures corresponding to the video signal on the screen 100. The voice control device 104 controls the processing circuit 102 according to voices of a user, and can be formed inside a housing of the display device 10 as shown in FIG. 1, or formed externally, which will be detailed hereinafter.

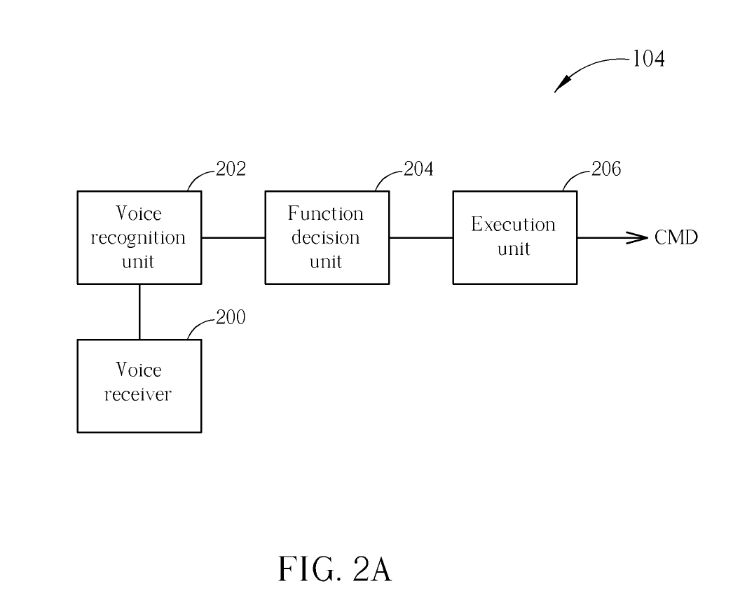

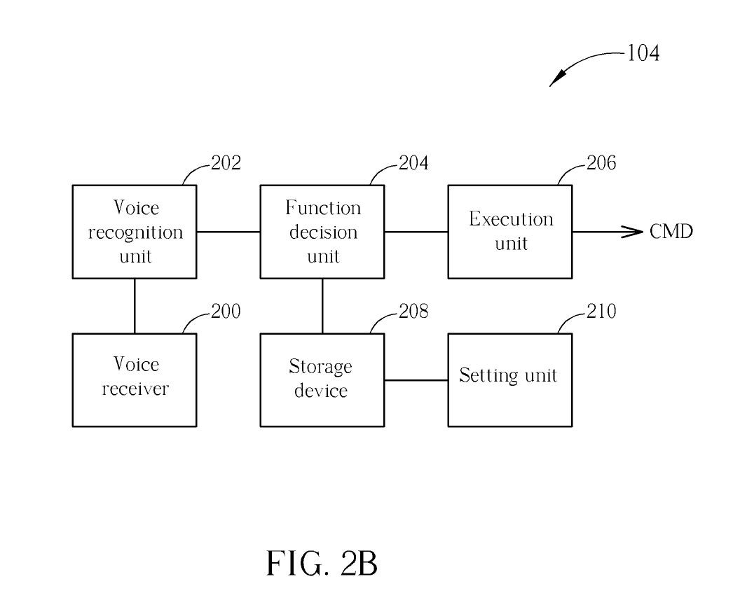

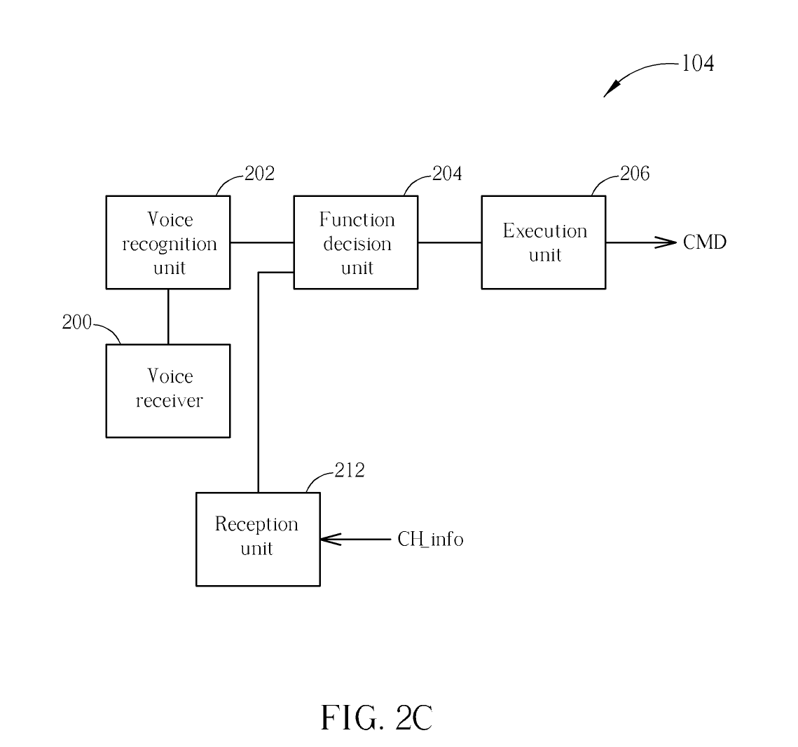

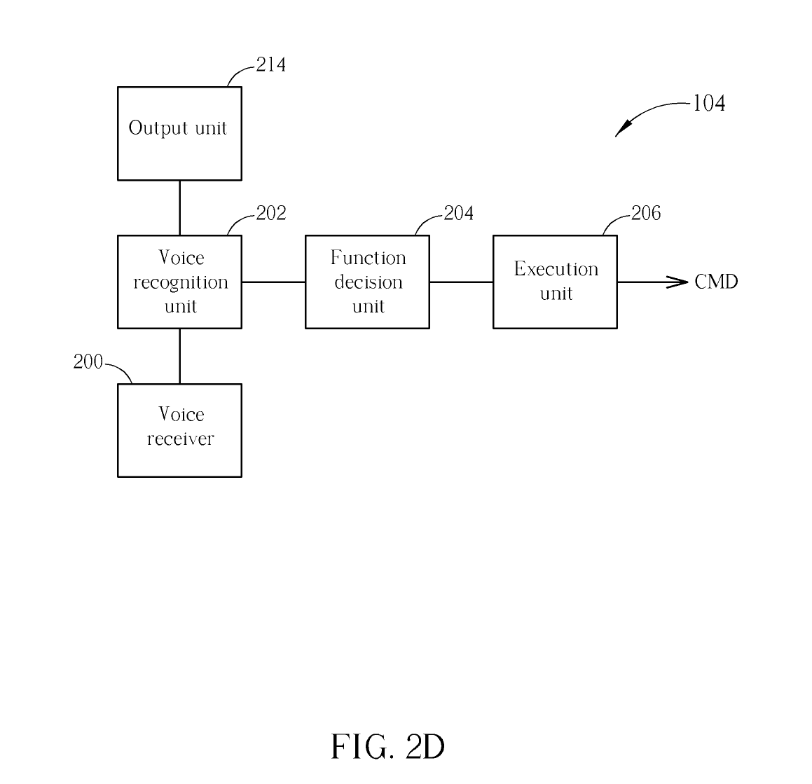

Please continue to refer to FIG. 2A, which is a schematic diagram of the voice control device 104 shown in FIG. 1. The voice control device 104 comprises a voice receiver 200, a voice recognition unit 202, a function decision unit 204, and an execution unit 206. The voice receiver 200 is used for receiving voice signals of the user, and transmitting the received voice signal to the voice recognition unit 202, in order to recognize contents of the voice signals and generate a corresponding recognition result. The function decision unit 204 determines which operating function the user wants to execute according to the recognition result provided by the voice recognition unit 202, and the execution unit 206 outputs a control command CMD accordingly, to control the processing circuit 102 to perform a corresponding operation.

In brief, when the voice receiver 200 receives a voice command from the user, the voice recognition unit 202 recognizes the contents thereof, and the function decision unit 204 determines the corresponding operating function, so as to control the processing circuit 102 to perform the required operating function via the control command CMD outputted by the execution unit 206. In other words, the user does not need to press any button formed on the housing of the display device 10 or use a remote control, while the user can control the processing circuit 102 to perform required operation functions. In such a situation, inconvenience or operating stress resulting from poor eyesight or unfamiliarity of new functions can be reduced. For example, a presbyopic user can orally control the display device 10 to execute a required operating function without repeating actions of wearing and taking off glasses, or concerning about wrong starts of some functions.

Note that, the voice control device 104 shown in FIG. 2A is an embodiment of the present invention, and those skilled in the art can make modifications accordingly. For example, as shown in FIG. 2B, a storage device 208 and a setting unit 210 are added to the structure shown in FIG. 2A. The setting unit 210 can set representative information of operating functions of the display device 10, and store the information in the storage device 208 in a form of a cross reference table, a lookup table or the like. In other words, the user can preset the operating functions to be corresponding to different voice signals, and the same operating function can be corresponding to more than one voice signal. For example, the user can use the setting unit 210 and set “Louder” or “Increase Volume” to be voice signals controlling the display device 10 to increase volume, while the storage device 208 stores the settings. As a result, when the user speaks “Increase Volume”, the voice recognition unit 202 recognizes the corresponding contents, then the function decision unit 204 determines an operating function of increasing volume according data stored in the storage device 208, and the execution unit 206 controls the processing circuit 102 to increase volume.

Furthermore, current television broadcast systems can provide program list functions; that is, an appended program list is transmitted with the broadcasting signals, which includes program information of all or part of TV channels, such as channel name, program title, program introduction, duration, classification, etc. In such a situation, as shown in FIG. 2C, the present invention further adds a reception unit 212 in the voice control device 104 shown in FIG. 2A, for receiving a program information CH_info of TV channels. As a result, the function decision unit 204 can compare the recognition result of the voice recognition unit 202 with the program information CH_info, and selects an appropriate channel. For example, if the program information CH_info shows that channel 19 is “Discovery Channel” showing “Man vs. Wild”, the user only needs to say “Discovery Channel” or “Man vs. Wild” (or partially “versus Wild” if well designed), then the function decision unit 204 determines that the user wants to select channel 19, and the execution unit 206 controls the processing circuit 102 to change to channel 19. Therefore, if the user knows a name of a program but is not sure of the corresponding channel number, the user can use the voice control device 104 shown in FIG. 2C to select a correct channel.

In addition, as shown in FIG. 2D, an output unit 214 is added to the voice control device 104 shown in FIG. 2A, for showing the recognition result of the voice recognition unit 202 on the screen 100, so as to enhance convenience. In such a situation, the user can determine whether the spoke commands are correctly identified.

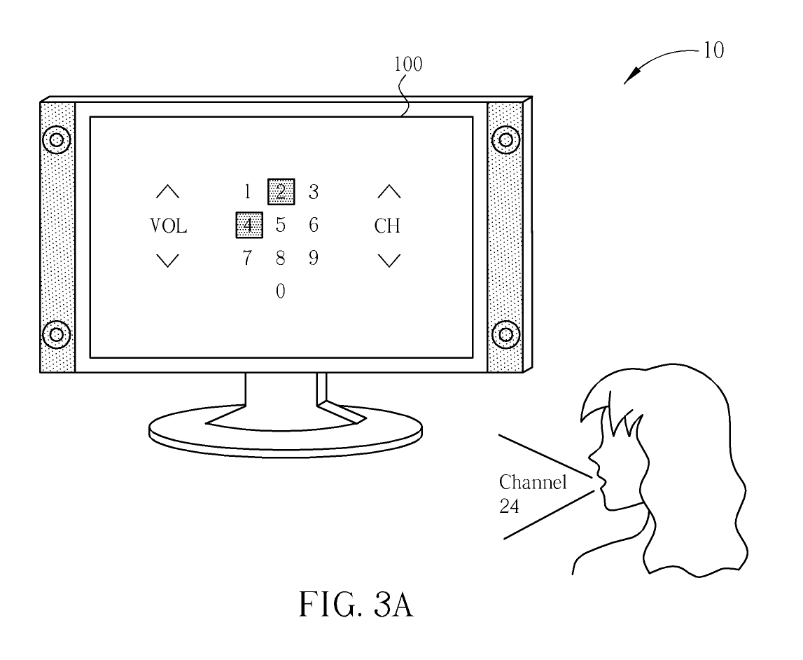

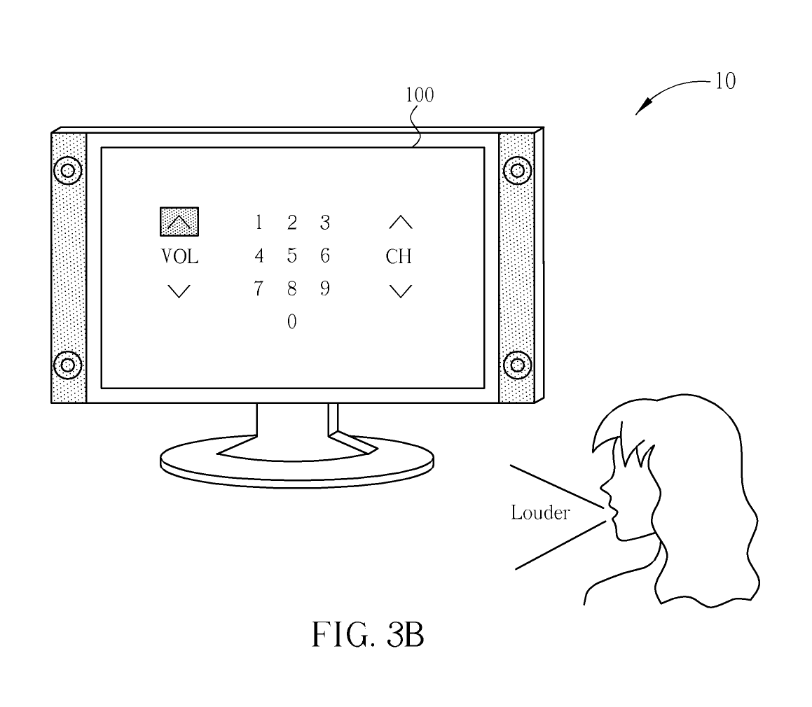

FIG. 2A to FIG. 2D show different embodiments of the voice control device 104, which are not independent, and can be mutually applied depending on design requirements. For example, when the embodiments of FIG. 2B and FIG. 2D are appropriately combined, operations of the display device 10 can be illustrated by examples shown in FIG. 3A and FIG. 3B . As shown in FIG. 3A, if the user has followed the example of FIG. 2B and set representative information of channel and volume control, when the user speaks out “Channel 24”, the voice control device 104 can determine that the user wants to select channel 24 and the corresponding recognition result is shown on the screen 100 according to the embodiment of FIG. 2D. Similarly, when the user speaks out “Louder”, the voice control device 104 can determine that the user wants to increase volume and the recognition result is displayed on the screen 100, as shown in FIG. 3B.

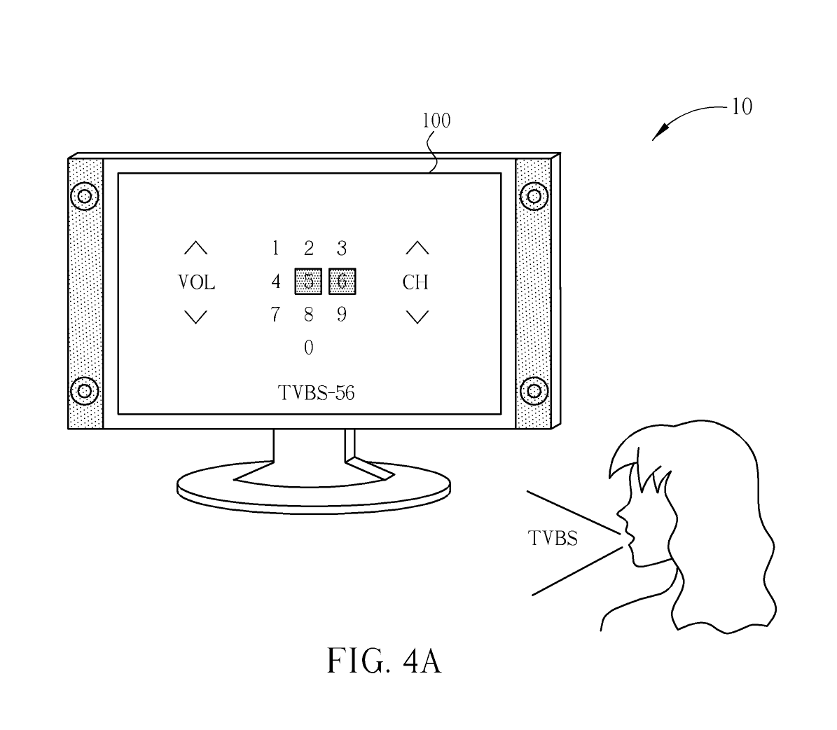

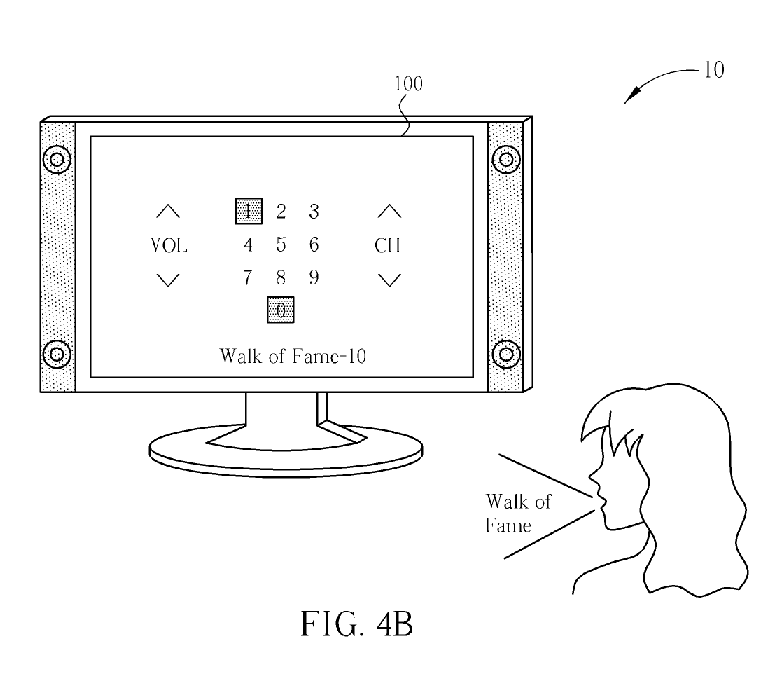

By the same token, if the embodiments of FIG. 2C and FIG. 2D are appropriately combined, operations of the display device 10 can be illustrated by examples shown in FIG. 4A and FIG. 4B . As shown in FIG. 4A, if the user has obtained the program information CH_info of each channel according to the embodiment of FIG. 2C, when the user speaks out “TVBS”, the voice control device 104 can determine that the user wants to select channel 56 corresponding to “TVBS channel” according to the program information CH_info, and the corresponding recognition result is displayed on the screen 100 according to the embodiment of FIG. 2D. Similarly, when the user speaks out “Walk of Fame”, the voice control device 104 determines that the user wants to select channel 10 which is showing “Walk of Fame” according to the program information CH_info, and the recognition result is displayed on the screen 100, as shown in FIG. 4B.

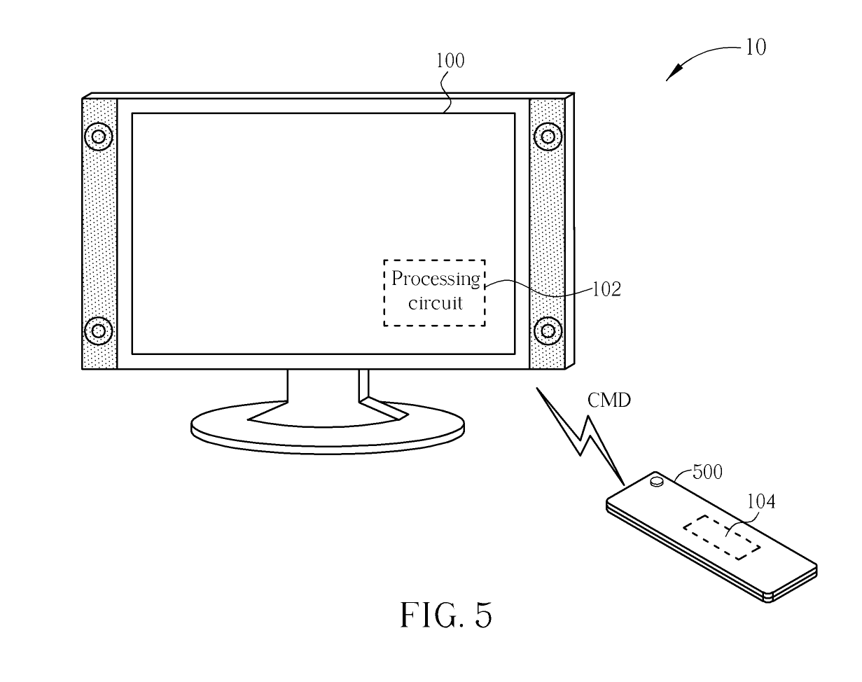

In addition, as mentioned above, the voice control device 104 can be formed inside the housing of the display device 10 as shown in FIG. 1, or formed outside the housing. For example, in FIG. 5, the voice control device 104 is formed inside a remote controller 500. Note that, when the voice control device 104 is formed inside the remote controller 500, operations of the voice control device 104 should be correspondingly modified; for example, the execution unit 206 should output the control command CMD via a wireless transmission channel, and such modification should be well known by those skilled in the art.

Moreover, to avoid the occurrence of erroneous control, a switch unit can be added, such as a button, to turn on or off the voice control device 104, to enhance convenience.

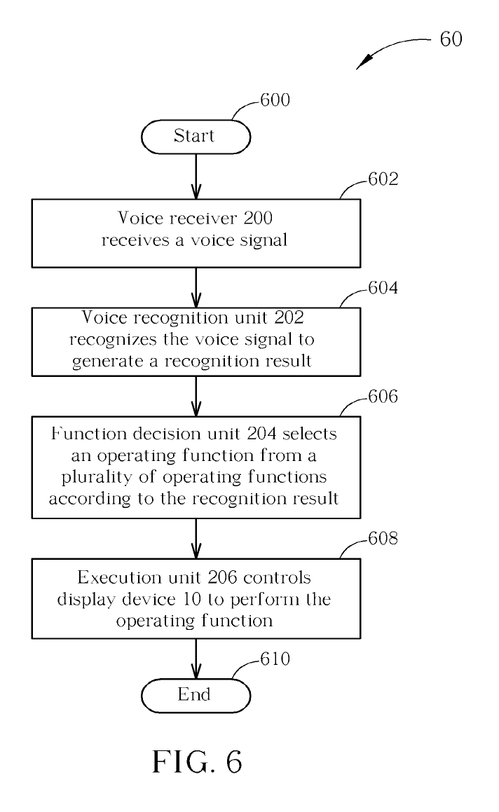

Furthermore, operations of the voice control device 104 can be summarized into a voice control procedure 60, as shown in FIG. 6. The voice control procedure 60 includes the following steps:

Step 600: Start.

Step 602: The voice receiver 200 receives a voice signal.

Step 604: The voice recognition unit 202 recognizes the voice signal, to generate a recognition result.

Step 606: The function decision unit 204 selects an operating function from a plurality of operating functions according to the recognition result.

Step 608: The execution unit 206 controls the display device 10 to perform the operating function.

Step 610: End.

The voice control procedure 60 represents the operations of the voice control device 104, and detail description can be referred in the above.

In the prior art, for users with poor eyesight, the limited size of characters shown on the remote controller can cause inconvenience, while for users unfamiliar to learn new functions, the complicated buttons of the remote controller may lead to stress for fear of erroneously triggering or damaging some functions. In comparison, the present invention uses voice recognition to determine an operating function required by the user, and controls the display device accordingly. Thus, the user does not need to operate any remote controller while controlling the display device, so as to enhance convenience, as well as reduce inconvenience and stress.

To summarize, the present invention controls the display device according to voices of a user, so as to greatly enhance utilization convenience.

Those skilled in the art will readily observe that numerous modifications and alterations of the device and method may be made while retaining the teachings of the invention.

What is claimed is:

1. A voice control device for a display device comprising:
a voice receiver, for receiving a voice signal;
a voice recognition unit, coupled to the voice receiver, for recognizing the voice signal, to generate a recognition result;
a function decision unit, coupled to the voice recognition unit, for selecting an operating function from a plurality of operating functions according to the recognition result; and
an execution unit, coupled to the function decision unit, for controlling the display device to perform the operating function.

2. The voice control device of claim 1, further comprising a storage unit, coupled to the function decision unit, for storing a plurality of representative information corresponding to the plurality of operating functions.

3. The voice control device of claim 2, wherein the function decision unit selects the operating function when the recognition result conforms to a representative information corresponding to the operating function within the plurality of representative information.

4. The voice control device of claim 2, further comprising a setting unit coupled to the storage unit for setting the plurality of representative information.

5. The voice control device of claim 1, wherein the display device is a television (TV) set for receiving broadcasting signals of a plurality of TV channels, to display a program of a TV channel.

6. The voice control device of claim 5, further comprising a reception unit, coupled to the function decision unit, for receiving program information of the plurality of TV channels.

7. The voice control device of claim 6, wherein the function decision unit determines the operating function is selecting a TV channel when the recognition result conforms to a program information of the TV channel, according to the program information of the plurality of TV channels received by the reception unit.

8. The voice control device of claim 1, further comprising an output unit, coupled to the voice recognition unit, for displaying the recognition result on a screen of the display device.

9. The voice control device of claim 1, wherein the execution unit controls the display device to perform the operating function via a wireless transmission channel.

10. A voice control method for a display device comprising:
receiving a voice signal;
recognizing the voice signal to generate a recognition result;
selecting an operating function from a plurality of operating functions according to the recognition result; and
controlling the display device to perform the operating function.

11. The voice control method of claim 10, further comprising storing a plurality of representative information corresponding to the plurality of operating functions.

12. The voice control method of claim 11, wherein the step of selecting the operating function from the plurality of operating functions according to the recognition result is selecting the operating function when the recognition result conforms to a representative information corresponding to the operating function within the plurality of representative information.

13. The voice control method of claim 11, further comprising setting the plurality of representative information.

14. The voice control method of claim 10, wherein the display device is a television (TV) set, for receiving broadcasting signals of a plurality of TV channels, to display a program of a TV channel.

15. The voice control method of claim 14, further comprising receiving program information of the plurality of TV channels.

16. The voice control method of claim 15, wherein the step of selecting the operating function from the plurality of operating functions according to the recognition result is determining the operating function is selecting a TV channel when the recognition result conforms to a program information of the TV channel, according to the program information of the plurality of TV channels.

17. The voice control method of claim 10, further comprising displaying the recognition result on a screen of the display device.

18. The voice control method of claim 10, wherein the step of controlling the display device to perform the operating function is controlling the display device to perform the operating function via a wireless transmission channel.

19. A display device comprising:
a screen;
a processing circuit for receiving a video signal and displaying pictures corresponding to the video signal on the screen; and
a voice control device comprising:
a voice receiver, for receiving a voice signal;
a voice recognition unit, coupled to the voice receiver, for recognizing the voice signal, to generate a recognition result;
a function decision unit, coupled to the voice recognition unit, for selecting an operating function from a plurality of operating functions according to the recognition result; and
an execution unit, coupled to the function decision unit, for controlling the processing circuit to perform the operating function.

20. The display device of claim 19, further comprising a storage unit, coupled to the function decision unit, for storing a plurality of representative information corresponding to the plurality of operating functions.

21. The display device of claim 20, wherein the function decision unit selects the operating function when the recognition result conforms to a representative information corresponding to the operating function within the plurality of representative information.

22. The display device of claim 20, further comprising a setting unit coupled to the storage unit for setting the plurality of representative information.

23. The display device of claim 19, wherein the video signal is a combination of broadcast signals of a plurality of TV channels, and the processing circuit is utilized for displaying a program content of a TV channel on the screen.

24. The display device of claim 19, further comprising a reception unit, coupled to the function decision unit, for receiving program information of the plurality of TV channels.

25. The display device of claim 24, wherein the function decision unit determines the operating function is selecting a TV channel when the recognition result conforms to a program information of the TV channel, according to the program information of the plurality of TV channels received by the reception unit.

26. The display device of claim 19, further comprising an output unit, coupled to the voice recognition unit, for displaying the recognition result on the screen.

27. The display device of claim 19, wherein the execution unit controls the display device to perform the operating function via a wireless transmission channel.
